(19) United States
(12) Patent Application Publication
(10) Pub. No.: US 2024/0183804 A1
(43) Pub. Date: Jun. 6, 2024

(54) X-RAY INSPECTION APPARATUS

(71) Applicant: JED Co., Ltd, Azumino-shi, Nagano (JP)

(72) Inventor: Osamu KINOSHITA, Azumino (JP)

(21) Appl. No.: 18/286,008

(22) PCT Filed: Feb. 15, 2022
(86) PCT No.: PCT/JP2022/005874

§ 371 Date: Oct. 6, 2023

(30) Foreign Application Priority Data
Apr. 22, 2021 (JP) 2021-072710

(51) Int. Cl. G01N 23/223; G01N 23/046

(52) U.S. Cl. CPC G01N 23/223; G01N 23/046; G01N 2223/419

(57) ABSTRACT

An X-ray inspection apparatus alternately performs an image acquisition operation and a movement operation, and causes a two-dimensional X-ray detector to acquire an X-ray image of an object to be inspected divided in a right and left direction at a predetermined position in an upper and lower direction, at every fixed angle in a relative rotation direction over 360°. A processing module that captures and processes the X-ray image acquires, after capturing a predetermined number of the X-ray images, data for creating a CT image including coordinates of a predetermined position in an acquired X-ray image as a captured X-ray image and brightness at the coordinates from the acquired X-ray image, and starts a predetermined arithmetic operation to generate a CT image of the object to be inspected using the data for creating a CT image.

### CROSS REFERENCE TO RELATED APPLICATIONS

This application is a 371 U.S. National Phase of International Application No. PCT/JP2022/005874, filed on Feb. 15, 2022, which claims priority to Japanese Patent Application No. 2021-072710, filed Apr. 22, 2021. The entire disclosures of the above applications are incorporated herein by reference.

### FIELD

The present invention relates to an X-ray inspection apparatus for nondestructively inspecting an inner part of an industrial product and the like.

### BACKGROUND

In the related art, there is known an X-ray inspection apparatus for nondestructively inspecting an inner part of an object to be inspected such as an industrial product (for example, refer to WO2017/203886). The X-ray inspection apparatus disclosed in WO2017/203886 includes an X-ray generator that emits X-rays to an object to be inspected, an area sensor (two-dimensional X-ray detector) that is placed to be opposed to the X-ray generator across the object to be inspected, a table on which the object to be inspected is mounted, a rotation mechanism that rotates the table, a movement mechanism that translates the area sensor, and a personal computer (PC) as a processing module that captures and processes an X-ray image acquired by the area sensor. The object to be inspected that is inspected by the X-ray inspection apparatus is relatively large. Thus, with this X-ray inspection apparatus, when the area sensor is moved to nine placement positions including a first placement position to a ninth placement position, the area sensor can acquire an X-ray image of the entire object to be inspected.

When the object to be inspected is inspected by the X-ray inspection apparatus disclosed in WO2017/203886, first, the area sensor is moved to and stopped at the first placement position. In this state, the object to be inspected is rotated once at a fixed speed, and a plurality of X-ray images are acquired by the area sensor at every fixed angle. Thereafter, the area sensor is moved to and stopped at a second placement position, the object to be inspected is rotated once at a fixed speed in this state, and a plurality of X-ray images are acquired by the area sensor at every fixed angle. Thereafter, the area sensor is successively moved to and stopped at a third placement position to the ninth placement position, the object to be inspected is rotated once at a fixed speed in this state, and a plurality of X-ray images are acquired by the area sensor at every fixed angle.

In the X-ray inspection apparatus disclosed in WO2017/203886, the PC generates a composite X-ray image by connecting and compositing X-ray images that are acquired when the area sensor is placed at the first placement position, the second placement position, and the third placement position, and acquired at the same angle in a relative rotation direction of the area sensor with respect to the object to be inspected. Similarly, the PC generates a composite X-ray image by connecting and compositing X-ray images that are acquired when the area sensor is placed at the fourth placement position, a fifth placement position, and a sixth placement position, and acquired at the same angle in the relative rotation direction of the area sensor with respect to the object to be inspected.

Furthermore, the PC generates a composite X-ray image by connecting and compositing X-ray images that are acquired when the area sensor is placed at a seventh placement position, an eighth placement position, and the ninth placement position, and acquired at the same angle in the relative rotation direction of the area sensor with respect to the object to be inspected. Thereafter, the PC performs predetermined processing on the composite X-ray images, and performs a predetermined arithmetic operation based on the composite X-ray images after the processing to generate a CT image of the object to be inspected.

In the X-ray inspection apparatus disclosed in WO2017/203886, the PC performs predetermined processing on the composite X-ray image after generating the composite X-ray image, so that the composite X-ray image needs to be at least temporarily stored. That is, the PC needs to at least temporarily store the composite X-ray image in addition to the X-ray images acquired by the area sensor. Thus, in a case of this X-ray inspection apparatus, a CT image of an object to be inspected cannot be generated in some cases unless storage capacity of a memory (storage module) of the PC is increased.

Thus, the present invention provides an X-ray inspection apparatus including an X-ray generator, a two-dimensional X-ray detector that is placed to be opposed to the X-ray generator across the object to be inspected, and a processing module that captures and processes an X-ray image acquired by the two-dimensional X-ray detector, the X-ray inspection apparatus being capable of generating the entire CT image of a relatively large object to be inspected even if storage capacity of a memory of a processing module is reduced.

### SUMMARY

To solve the problem described above, an X-ray inspection apparatus according to the present invention includes: an X-ray generator; a two-dimensional X-ray detector that is placed to be opposed to the X-ray generator across an object to be inspected; a rotation mechanism that rotates the X-ray generator and the two-dimensional X-ray detector or rotates the object to be inspected so that, on an outer peripheral side of the object to be inspected, the X-ray generator and the two-dimensional X-ray detector are rotated relatively to the object to be inspected; a processing module that captures and processes an X-ray image acquired by the two-dimensional X-ray detector; where a first direction is a predetermined direction parallel to a detection face of the two-dimensional X-ray detector, a second direction is a direction that is parallel to the detection face and orthogonal to the first direction, and a relative rotation direction is a direction of relative rotation of the X-ray generator and the two-dimensional X-ray detector with respect to the object to be inspected, a movement mechanism that translates the two-dimensional X-ray detector or translates the object to be inspected so that the two-dimensional X-ray detector moves at least in the first direction relatively to the object to be inspected; and a control unit to which the X-ray generator, the two-dimensional X-ray detector, the rotation mechanism, and the movement mechanism are connected, in which, where a virtual projection plane is a plane including the detection face, and a virtual projection image is the entire projection image of the object to be inspected projected on the virtual projection plane by X-rays emitted from the X-ray generator, the detection face is smaller than the virtual projection image at least in the first direction, the control unit alternately performs an image acquisition operation of causing the rotation mechanism to rotate the X-ray generator and the two-dimensional X-ray detector by 360° relatively to the object to be inspected and causing the two-dimensional X-ray detector to acquire an X-ray image at every fixed angle and a movement operation of causing the movement mechanism to relatively move the two-dimensional X-ray detector toward one side of the first direction with respect to the object to be inspected, and causes the two-dimensional X-ray detector to acquire X-ray images of the object to be inspected divided in the first direction at the predetermined position in the second direction, at every fixed angle in the relative rotation direction over 360°, and the processing module acquires, after capturing a predetermined number of the X-ray images acquired by the two-dimensional X-ray detector, data for creating a CT image including coordinates of the predetermined position in an acquired X-ray image as the captured X-ray image and brightness at the coordinates from the acquired X-ray image, and starts a predetermined arithmetic operation to generate a CT image of the object to be inspected using the data for creating a CT image.

In the X-ray inspection apparatus according to the present invention, the control unit alternately performs the image acquisition operation and the movement operation, and causes the two-dimensional X-ray detector to acquire the X-ray image of the object to be inspected divided in the first direction at the predetermined position in the second direction, at every fixed angle in the relative rotation direction over 360°. The processing module acquires, after capturing a predetermined number of the X-ray images acquired by the two-dimensional X-ray detector, data for creating a CT image including coordinates of the predetermined position in the acquired X-ray image as the captured X-ray image and brightness at the coordinates from the acquired X-ray image, and starts a predetermined arithmetic operation to generate a CT image of the object to be inspected using the data for creating a CT image. Thus, in the present invention, a CT image can be generated even if the processing module does not generate and store the composite X-ray image like the PC disclosed in WO2017/203886. That is, in the present invention, the processing module does not need to store the composite X-ray image to generate the CT image. Thus, in the present invention, the entire CT image of a relatively large object to be inspected can be generated even if the storage capacity of the memory of the processing module is reduced.

In the present invention, it is preferable that the processing module acquires data for creating a CT image before capturing all X-ray images required for generating a CT image of the object to be inspected, and starts the arithmetic operation to generate the CT image of the object to be inspected using the data for creating a CT image. With such a configuration, as compared with a case in which the processing module acquires the data for creating a CT image and starts the arithmetic operation to generate the CT image of the object to be inspected after capturing all X-ray images required for generating the CT image of the object to be inspected, a time until the CT image is generated can be shortened.

In the present invention, for example, the detection face is smaller than the virtual projection image in the first direction and the second direction, and assuming that a column of X-ray images is X-ray images of the object to be inspected divided in the first direction at the predetermined position in the second direction acquired, at every fixed angle in the relative rotation direction over 360°, when the column of X-ray images is acquired by the two-dimensional X-ray detector, the control unit causes the movement mechanism to move the two-dimensional X-ray detector relatively to the object to be inspected at least in the second direction, alternately performs the image acquisition operation and the movement operation thereafter, and causes the two-dimensional X-ray detector to acquire the next column of X-ray images of the object to be inspected in the second direction.

### Advantageous Effects of Invention

As described above, in the present invention, with the X-ray inspection apparatus including an X-ray generator, a two-dimensional X-ray detector that is placed to be opposed to the X-ray generator across the object to be inspected, and a processing module that captures and processes an X-ray image acquired by the two-dimensional X-ray detector, the entire CT image of a relatively large object to be inspected can be generated even if the storage capacity of the memory of the processing module is reduced.

### BRIEF DESCRIPTION OF THE DRAWINGS

FIG. 1 is a schematic diagram of a mechanical configuration of an X-ray inspection apparatus according to an embodiment of the present invention.

FIG. 2 is a block diagram for explaining a schematic configuration of the X-ray inspection apparatus illustrated in FIG. 1.

### DETAILED DESCRIPTION

Embodiments of the present invention will be described below with reference to the drawings.

### (Configuration of X-Ray Inspection Apparatus)

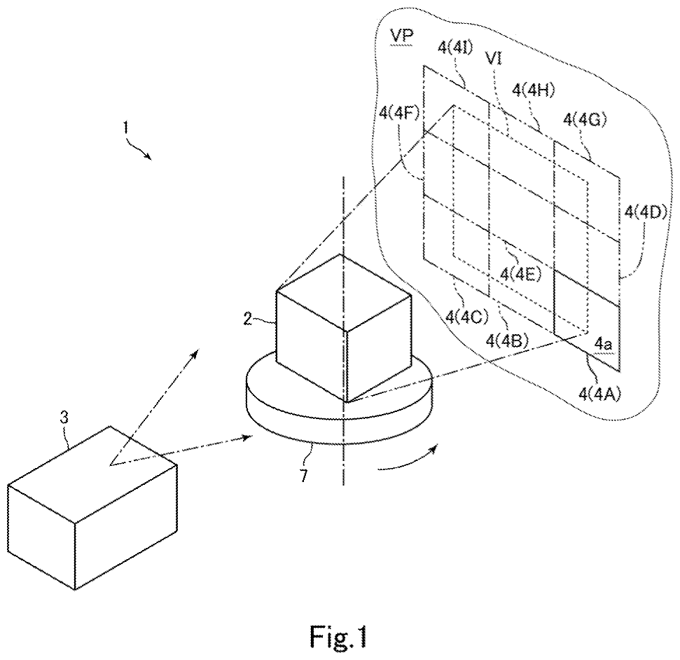

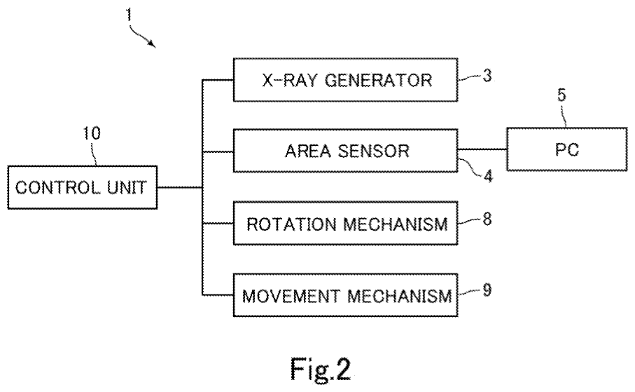

FIG. 1 is a schematic diagram of a mechanical configuration of an X-ray inspection apparatus 1 according to an embodiment of the present invention. FIG. 2 is a block diagram for explaining a schematic configuration of the X-ray inspection apparatus 1 illustrated in FIG. 1.

The X-ray inspection apparatus 1 according to the present embodiment is an apparatus for nondestructively inspecting an inner part of an object 2 to be inspected such as an industrial product. Specifically, the X-ray inspection apparatus 1 is an apparatus for inspecting the object 2 to be inspected such as an engine block that is relatively large. The X-ray inspection apparatus 1 includes an X-ray generator 3 that emits X-rays to the object 2 to be inspected, and a two-dimensional X-ray detector 4 (hereinafter, referred to as an “area sensor 4”) that is placed to be opposed to the X-ray generator 3 across the object 2 to be inspected.

The X-ray inspection apparatus 1 also includes a processing module 5 that captures and processes the X-ray image acquired by the area sensor 4, a table 7 on which the object 2 to be inspected is mounted, a rotation mechanism 8 that rotates the table 7, and a movement mechanism 9 that translates the area sensor 4. The X-ray generator 3, the area sensor 4, the rotation mechanism 8, and the movement mechanism 9 are connected to a control unit 10. The processing module 5 is a personal computer (PC) including a memory (storage module) such as a semiconductor memory, a CPU, and the like. Thus, the processing module 5 is referred to as a “PC 5” hereinafter. The PC 5 is connected to the area sensor 4.

The X-ray generator 3 emits cone-shaped X-rays (cone beam) toward the object 2 to be inspected, for example. An optical axis of the X-ray generator 3 is parallel to a horizontal direction. The area sensor 4 is a two-dimensional camera. A detection face 4a of the area sensor 4 is formed in a rectangular shape. Specifically, the detection face 4a is formed in a square shape. A length of one side of the detection face 4a is 200 (mm), for example. Assuming that a direction parallel to the optical axis of the X-ray generator 3 is a front and rear direction, the detection face 4a is placed to be orthogonal to the front and rear direction. Assuming that a direction orthogonal to an upper and lower direction and the front and rear direction is a right and left direction, the area sensor 4 is placed so that two of the four sides of the detection face 4a formed in a square shape are parallel to the upper and lower direction, and the other two sides are parallel to the right and left direction. The right and left direction according to the present embodiment is a first direction as a predetermined direction parallel to the detection face 4a, and the upper and lower direction is a second direction that is a direction parallel to the detection face 4a and orthogonal to the first direction.

The table 7 is placed between the X-ray generator 3 and the area sensor 4 in the front and rear direction so that the object 2 to be inspected is placed between the X-ray generator 3 and the area sensor 4. The rotation mechanism 8 rotates the table 7 using the upper and lower direction as an axial direction of the rotation. That is, the rotation mechanism 8 rotates the object 2 to be inspected mounted on the table 7 so that the, on an outer peripheral side of the object 2 to be inspected, X-ray generator 3 and the area sensor 4 are rotated relatively to the object 2 to be inspected. The movement mechanism 9 translates the area sensor 4 in the right and left direction and the upper and lower direction. That is, the movement mechanism 9 translates the area sensor 4 so that the area sensor 4 is moved in the right and left direction and the upper and lower direction relatively to the object 2 to be inspected. Hereinafter, a direction of relative rotation of the X-ray generator 3 and the area sensor 4 with respect to the object 2 to be inspected is referred to as a “relative rotation direction” in some cases.

Assuming that a plane including the detection face 4a of the area sensor 4 is a virtual projection plane VP, and a projection image of the entire object 2 to be inspected that is projected on the virtual projection plane VP by X-rays emitted from the X-ray generator 3 is a virtual projection image VI, the detection face 4a is smaller than the virtual projection image VI in the upper and lower direction and the right and left direction. In the present embodiment, an X-ray image of the entire object 2 to be inspected can be acquired by the area sensor 4 by moving the area sensor 4 to nine positions.

Specifically, the X-ray image of the entire object 2 to be inspected can be acquired by the area sensor 4 by moving the area sensor 4 to nine positions including a first placement position 4A at which a right end side of a lower end side portion of the object 2 to be inspected is projected, a second placement position 4B at which a center part in the right and left direction of the lower end side portion of the object 2 to be inspected is projected, a third placement position 4C at which a left end side of the lower end side portion of the object 2 to be inspected is projected, a fourth placement position 4D at which a right end side of a center portion in the upper and lower direction of the object 2 to be inspected is projected, a fifth placement position 4E at which a center portion of the object 2 to be inspected is projected, a sixth placement position 4F at which a left end side of the center portion in the upper and lower direction of the object 2 to be inspected is projected, a seventh placement position 4G at which a right end side of an upper end side portion of the object 2 to be inspected is projected, an eighth placement position 4H at which a center part in the right and left direction of the upper end side portion of the object 2 to be inspected is projected, and a ninth placement position 4I at which a left end side of the upper end side portion of the object 2 to be inspected is projected.

When the area sensor 4 placed at the first placement position 4A is moved to the left side by a length of one side of the detection face 4a, the area sensor 4 is placed at the second placement position 4B, and when the area sensor 4 placed at the second placement position 4B is moved to the left side by a length of one side of the detection face 4a, the area sensor 4 is placed at the third placement position 4C. When the area sensor 4 placed at the third placement position 4C is moved to the right side by double of the length of one side of the detection face 4a and moved to an upper side by the length of one side of the detection face 4a, the area sensor 4d is placed at the fourth placement position 4D.

Similarly, when the area sensor 4 placed at the fourth placement position 4D is moved to the left side by the length of one side of the detection face 4a, the area sensor 4 is placed at the fifth placement position 4E, and when the area sensor 4 placed at the fifth placement position 4E is moved to the left side by the length of one side of the detection face 4a, the area sensor 4 is placed at the sixth placement position 4F. When the area sensor 4 placed at the sixth placement position 4F is moved to the right side by double of the length of one side of the detection face 4a and moved to the upper side by the length of one side of the detection face 4a, the area sensor 4 is placed at the seventh placement position 4G, when the area sensor 4 placed at the seventh placement position 4G is moved to the left side by the length of one side of the detection face 4a, the area sensor 4 is placed at the eighth placement position 4H, and when the area sensor 4 placed at the eighth placement position 4H is moved to the left side by the length of one side of the detection face 4a, the area sensor 4 is placed at the ninth placement position 4I.

In the present embodiment, part of the object 2 to be inspected is projected on the detection face 4a of the area sensor 4 regardless of whether the area sensor 4 is placed at any of the first placement position 4A to the ninth placement position 4I. However, when the area sensor 4 is placed at any of the first placement position 4A to the ninth placement position 4I, part of the object 2 to be inspected is not necessarily projected on the detection face 4a. In the present embodiment, an irradiation region of the X-ray generator 3 is set so that the virtual projection image VI is projected on the virtual projection plane VP without moving the X-ray generator 3.

### (Method for Acquiring X-Ray Image)

When the object 2 to be inspected is inspected by the X-ray inspection apparatus 1, the X-ray inspection apparatus 1 acquires an X-ray image of the object 2 to be inspected as follows. First, the control unit 10 adjust the rotation mechanism 8 so that a rotational position of the rotation mechanism 8 becomes a predetermined origin position. The control unit 10 causes the movement mechanism 9 to move the area sensor 4 to the first placement position 4A to be stopped, for example. In this state, the control unit 10 performs an image acquisition operation of causing the rotation mechanism 8 to rotate the object 2 to be inspected mounted on the table 7 at a fixed speed over 360°, and causing the area sensor 4 to acquire X-ray images A1 to A1000 at every fixed angle. In the image acquisition operation according to the present embodiment, 1000 X-ray images A1 to A1000 are successively acquired at every 0.36°. The number of X-ray images acquired in the image acquisition operation may be smaller than 1000, or may be larger than 1000.

Thereafter, the control unit 10 performs a movement operation of causing the movement mechanism 9 to move the area sensor 4 in the left direction. In this movement operation, the area sensor 4 is moved from the first placement position 4A to the second placement position 4B to be stopped. In this state, the control unit 10 performs the image acquisition operation of causing the rotation mechanism 8 to rotate the object 2 to be inspected at a fixed speed over 360°, and causing the area sensor 4 to successively acquire 1000 X-ray images B1 to B1000 at every 0.36°. Thereafter, the control unit 10 performs the movement operation of causing the movement mechanism 9 to move the area sensor 4 from the second placement position 4B to the third placement position 4C, and performs the image acquisition operation of causing the rotation mechanism 8 to rotate the object 2 to be inspected at a fixed speed over 360° and causing the area sensor 4 to successively acquire 1000 X-ray images C1 to C1000 at every 0.36°.

The X-ray images A1, B1, and C1 are X-ray images that are acquired at the same angle in the relative rotation direction of the area sensor 4 with respect to the object 2 to be inspected. When the X-ray images A1, B1, and C1 are placed in this order from the right side to be connected, obtained is an X-ray image of an origin position in the relative rotation direction of the lower end side portion of the object 2 to be inspected. That is, each of the X-ray images A1, B1, and C1 is an X-ray image of an origin position in the relative rotation direction of the lower end side portion of the object 2 to be inspected, and is also an X-ray image divided in the right and left direction.

Similarly, X-ray images A2, B2, and C2 are X-ray images that are acquired at the same angle in the relative rotation direction. When the X-ray images A2, B2, and C2 are placed in this order from the right side to be connected, obtained is an X-ray image of a position shifted by 0.36° from the origin position in the relative rotation direction of the lower end side portion of the object 2 to be inspected. That is, each of the X-ray images A2, B2, and C2 is an X-ray image of a position shifted by 0.36° from the origin position in the relative rotation direction of the lower end side portion of the object 2 to be inspected, and is also an X-ray image divided in the right and left direction.

That is, assuming that “n” is an integer number from 1 to 1000, X-ray images An, Bn, and Cn are X-ray images that are acquired at the same angle in the relative rotation direction, and when the X-ray images An, Bn, and Cn are placed in this order from the right side to be connected, obtained is an X-ray image of a position shifted by (0.36× (n−1))° from the origin position in the relative rotation direction of the lower end side portion of the object 2 to be inspected. Each of the X-ray images An, Bn, and Cn is an X-ray image of a position shifted by (0.36×(n−1))° from the origin position in the relative rotation direction of the lower end side portion of the object 2 to be inspected, and is also an X-ray image divided in the right and left direction.

As described above, when the image acquisition operation and the movement operation are alternately performed, the X-ray image of the lower end side portion of the object 2 to be inspected divided in the right and left direction is acquired at every 0.36° in the relative rotation direction over 360°. That is, the control unit 10 alternately performs the image acquisition operation of causing the rotation mechanism 8 to rotate the X-ray generator 3 and the area sensor 4 by 360° relatively to the object 2 to be inspected in a state in which the area sensor 4 is stopped and causing the area sensor 4 to acquire the X-ray image at every fixed angle, and the movement operation of causing the movement mechanism 9 to move the area sensor 4 in the left direction relatively to the object 2 to be inspected to cause the area sensor 4 to acquire the X-ray image of the lower end side portion of the object 2 to be inspected divided in the right and left direction, at every fixed angle in the relative rotation direction over 360°.

Assuming that a column of X-ray images P1 is a plurality of X-ray images of the lower end side portion of the object 2 to be inspected that are divided in the right and left direction and acquired at every fixed angle in the relative rotation direction over 360°, when the area sensor 4 acquires the column of X-ray images P1, the control unit 10 causes the movement mechanism 9 to move the area sensor 4 from the third placement position 4C to the fourth placement position 4D. That is, the control unit 10 causes the movement mechanism 9 to move the area sensor 4 in the right direction and the upper direction.

Thereafter, the control unit 10 performs the same image acquisition operation as the image acquisition operation described above to cause the area sensor 4 placed at the fourth placement position 4D to acquire X-ray images D1 to D1000, and performs the same movement operation as the movement operation described above to cause the area sensor 4 to move from the fourth placement position 4D to the fifth placement position 4E. Similarly, the control unit 10 performs the image acquisition operation to cause the area sensor 4 placed at the fifth placement position 4E to acquire X-ray images E1 to E1000, performs the movement operation to cause the area sensor 4 to move from the fifth placement position 4E to the sixth placement position 4F, and performs the image acquisition operation to cause the area sensor 4 placed at the sixth placement position 4F to acquire X-ray images F1 to F1000 thereafter.

As described above, when the area sensor 4 acquires the column of X-ray images P1, the control unit 10 causes the movement mechanism 9 to move the area sensor 4 in the right direction and the upper direction, and alternately performs the image acquisition operation and the movement operation to cause the area sensor 4 to acquire the X-ray image of the center portion of the object 2 to be inspected in the upper and lower direction divided in the right and left direction, at every 0.36° in the relative rotation direction over 360°. That is, assuming that a column of X-ray images P2 is a plurality of X-ray images of the center portion of the object 2 to be inspected in the upper and lower direction that are divided in the right and left direction and acquired at every fixed angle in the relative rotation direction over 360°, when the area sensor 4 acquires the column of X-ray images P1, the control unit 10 causes the movement mechanism 9 to move the area sensor 4 in the right direction and the upper direction, and alternately performs the image acquisition operation and the movement operation to cause the area sensor 4 to acquire the next column of X-ray images P2 in the upper and lower direction of the object 2 to be inspected.

When the area sensor 4 acquires the column of X-ray images P2, the control unit 10 causes the movement mechanism 9 to move the area sensor 4 from the sixth placement position 4F to the seventh placement position 4G. Thereafter, similarly, the control unit 10 performs the image acquisition operation to cause the area sensor 4 placed at the seventh placement position 4G to acquire X-ray images G1 to G1000, and performs the movement operation to cause the area sensor 4 to move from the seventh placement position 4G to the eighth placement position 4H. Similarly, the control unit 10 performs the image acquisition operation to cause the area sensor 4 placed at the eighth placement position 4H to acquire X-ray images H1 to H1000, performs the movement operation to cause the area sensor 4 to move from the eighth placement position 4H to the ninth placement position 4I, and performs the image acquisition operation to cause the area sensor 4 placed at the ninth placement position 4I to acquire X-ray images I1 to I1000 thereafter. When the X-ray images I1 to I1000 are acquired, acquisition of the X-ray images of the object 2 to be inspected by the area sensor 4 ends.

As described above, when the area sensor 4 acquires the column of X-ray images P2, the control unit 10 causes the movement mechanism 9 to move the area sensor 4 in the right direction and the upper direction, and alternately performs the image acquisition operation and the movement operation to cause the area sensor 4 to acquire the X-ray image of the upper end side portion of the object 2 to be inspected divided in the right and left direction, at every 0.36° in the relative rotation direction over 360º. That is, assuming that a column of X-ray images P3 is a plurality of X-ray images of the upper end side portion of the object 2 to be inspected that are divided in the right and left direction and acquired at every fixed angle in the relative rotation direction over 360°, when the area sensor 4 acquires the column of X-ray images P2, the control unit 10 causes the movement mechanism 9 to move the area sensor 4 in the right direction and the upper direction, and alternately performs the image acquisition operation and the movement operation to cause the area sensor 4 to acquire the next column of X-ray images P3 in the upper and lower direction of the object 2 to be inspected.

### (Processing Method by PC)

The PC 5 successively captures the X-ray images acquired by the area sensor 4. After capturing a predetermined number of the X-ray images acquired by the area sensor 4, the PC 5 acquires data for creating a CT image including coordinates of a predetermined position in an acquired X-ray image as the captured X-ray image and brightness at the coordinates (that is, data for creating a CT image including coordinate data and luminance data) from the acquired X-ray image. After acquiring the data for creating a CT image, the PC 5 starts a predetermined arithmetic operation to generate a CT image of the object 2 to be inspected by using the acquired data for creating a CT image. Specifically, the PC 5 puts the acquired data for creating a CT image into a predetermined arithmetic expression.

For example, after capturing the X-ray images A1 to A1000, B1 to B1000, and C1 to C1000 (that is, after capturing the column of X-ray images P1 including 3000 X-ray images), the PC 5 acquires the data for creating a CT image from each of the acquired X-ray images A1 to A1000, B1 to B1000, C1 to C1000 as captured X-ray images, and starts the predetermined arithmetic operation to generate a CT image of the object 2 to be inspected by using the acquired data for creating a CT image.

Thereafter, after capturing the X-ray images D1 to D1000, E1 to E1000, and F1 to F1000 (that is, after capturing the column of X-ray images P2), the PC 5 acquires the data for creating a CT image from each of the acquired X-ray images D1 to D1000, E1 to E1000, and F1 to F1000, and starts the predetermined arithmetic operation to generate a CT image of the object 2 to be inspected by using the acquired data for creating a CT image. Thereafter, after capturing the X-ray images G1 to G1000, H1 to H1000, and I1 to I1000 (that is, after capturing the column of X-ray images P3), the PC 5 acquires the data for creating a CT image from each of the X-ray images G1 to G1000, H1 to H1000, and I1 to I1000, and starts the predetermined arithmetic operation to generate a CT image of the object 2 to be inspected by using the acquired data for creating a CT image.

For example, after capturing the X-ray images A1 to A1000 (that is, after capturing 1000 X-ray images), the PC 5 may acquire the data for creating a CT image from each of the acquired X-ray images A1 to A1000, and start the predetermined arithmetic operation to generate a CT image of the object 2 to be inspected by using the acquired data for creating a CT image. In this case, thereafter, after capturing the X-ray images B1 to B1000, the PC 5 acquires the data for creating a CT image from each of the acquired X-ray images B1 to B1000, and starts the predetermined arithmetic operation to generate a CT image of the object 2 to be inspected by using the acquired data for creating a CT image.

Thereafter, similarly, each time the PC 5 successively captures the X-ray images C1 to C1000, the X-ray images D1 to D1000, the X-ray images E1 to E1000, the X-ray images F1 to F1000, the X-ray images G1 to G1000, the X-ray images H1 to H1000, and the X-ray image I1 to I1000, the PC 5 acquires the data for creating a CT image from each of the acquired X-ray images C1 to C1000, the acquired X-ray images D1 to D1000, the acquired X-ray images E1 to E1000, the acquired X-ray images F1 to F1000, the acquired X-ray images G1 to G1000, the acquired X-ray images H1 to H1000, and the acquired X-ray image I1 to I1000, and starts the predetermined arithmetic operation to generate a CT image of the object 2 to be inspected by using the acquired data for creating a CT image.

As described above, in the present embodiment, before capturing all of the X-ray images A1 to A1000, B1 to B1000, C1 to C1000, D1 to D1000, E1 to E1000, F1 to F1000, G1 to G1000, H1 to H1000, and I1 to I1000 required for generating a CT image of the object 2 to be inspected, the PC 5 acquires the data for creating a CT image, and starts the predetermined arithmetic operation to generate a CT image of the object 2 to be inspected by using the acquired data for creating a CT image.

### (Main Effects of Present Embodiment)

As described above, in the present embodiment, the PC 5 acquires, after capturing the predetermined number of the X-ray images, the data for creating a CT image including coordinates of the predetermined position in the acquired X-ray image as the captured X-ray image and brightness at the coordinates from the acquired X-ray image, and starts the predetermined arithmetic operation to generate a CT image of the object 2 to be inspected using the data for creating a CT image. Thus, in the present embodiment, a CT image can be generated even if the PC 5 does not generate and store the composite X-ray image like the PC disclosed in WO2017/203886. That is, in the present embodiment, the PC 5 does not need to store the composite X-ray image to generate the CT image. Thus, in the present embodiment, the entire CT image of the object 2 to be inspected that is relatively large can be generated even if the storage capacity of the memory of the PC 5 is reduced.

In the present embodiment, before capturing all of the X-ray images A1 to A1000, B1 to B1000, C1 to C1000, D1 to D1000, E1 to E1000, F1 to F1000, G1 to G1000, H1 to H1000, and I1 to I1000 required for generating a CT image of the object 2 to be inspected, the PC 5 acquires the data for creating a CT image, and starts the predetermined arithmetic operation to generate a CT image of the object 2 to be inspected by using the acquired data for creating a CT image. Thus, in the present embodiment, as compared with a case in which the PC 5 acquires the data for creating a CT image and starts the arithmetic operation to generate the CT image of the object 2 to be inspected after capturing all X-ray images required for generating the CT image of the object 2 to be inspected, a time until the CT image is generated can be shortened.

### Other Embodiments

In the embodiment described above, a timing when the PC 5 acquires the data for creating a CT image from the acquired X-ray image and starts the predetermined arithmetic operation to generate the CT image of the object 2 to be inspected by using the data for creating a CT image may be after the PC 5 captures several X-ray images. In this case, it is preferable that, before capturing all of the X-ray images A1 to A1000, B1 to B1000, C1 to C1000, D1 to D1000, E1 to E1000, F1 to F1000, G1 to G1000, H1 to H1000, and I1 to I1000 required for generating a CT image of the object 2 to be inspected, the PC 5 acquires the data for creating a CT image from the acquired X-ray image, and starts the predetermined arithmetic operation to generate a CT image of the object 2 to be inspected by using the data for creating a CT image.

Alternatively, after capturing all of the X-ray images A1 to A1000, B1 to B1000, C1 to C1000, D1 to D1000, E1 to E1000, F1 to F1000, G1 to G1000, H1 to H1000, and I1 to I1000 required for generating a CT image of the object 2 to be inspected, the PC 5 may acquire the data for creating a CT image from the acquired X-ray image, and start the predetermined arithmetic operation to generate a CT image of the object 2 to be inspected by using the data for creating a CT image. Even in this case, the PC 5 does not need to generate and store the composite X-ray image like the PC disclosed in WO2017/203886, so that the entire CT image of the object 2 to be inspected that is relatively large can be generated even if the storage capacity of the memory of the PC 5 is reduced.

In the embodiment described above, the rotation mechanism 8 may rotate the X-ray generator 3 and the area sensor 4. In the embodiment described above, the movement mechanism 9 may translate the object 2 to be inspected in the upper and lower direction and the right and left direction. The movement mechanism 9 may translate the area sensor 4 in the right and left direction. In this case, the X-ray inspection apparatus 1 includes a movement mechanism that translates the object 2 to be inspected in the upper and lower direction. The movement mechanism 9 may translate the object 2 to be inspected in the right and left direction. In this case, the X-ray inspection apparatus 1 includes a movement mechanism that translates the area sensor 4 in the upper and lower direction. In the embodiment described above, the movement mechanism 9 may translate the X-ray generator 3 together with the area sensor 4 in the upper and lower direction and the right and left direction. In this case, for example, the irradiation region of the X-ray generator 3 is set so that the virtual projection image VI (projection image of the entire object 2 to be inspected) cannot be projected on the virtual projection plane VP unless the X-ray generator 3 is moved.

In the embodiment described above, the X-ray image of the entire object 2 to be inspected can be acquired by the area sensor 4 when the area sensor 4 is moved to nine positions including the first placement position 4A to the ninth placement position 4I. Alternatively, for example, the X-ray image of the entire object 2 to be inspected may be acquired by the area sensor 4 when the area sensor 4 is moved to six positions including the first placement position 4A to the sixth placement position 4F. The X-ray image of the entire object 2 to be inspected may be acquired by the area sensor 4 when the area sensor 4 is moved to four positions including the first placement position 4A, the second placement position 4B, the fourth placement position 4D, and the fifth placement position 4E. Furthermore, the X-ray image of the entire object 2 to be inspected may be acquired by the area sensor 4 when the area sensor 4 is moved to three positions including the first placement position 4A to the third placement position 4C. In this case, the detection face 4a is larger than the virtual projection image VI in the upper and lower direction.

In the embodiment described above, the number of times of movement of the area sensor 4 from the first placement position 4A to the third placement position 4C at the same height (hereinafter, referred to as a “number of times of movement at a first stage”), the number of times of movement of the area sensor 4 from the fourth placement position 4D to the sixth placement position 4F at the same height (hereinafter, referred to as a “number of times of movement at a second stage”), and the number of times of movement of the area sensor 4 from the seventh placement position 4G to the ninth placement position 4I at the same height (hereinafter, referred to as a “number of times of movement at a third stage”) are equal to each other. However, the number of times of movement at the first stage, the number of times of movement at the second stage, and the number of times of movement at the third stage may be different from each other depending on the shape of the object 2 to be inspected.

In the embodiment described above, the area sensor 4 may move from the third placement position 4C to the sixth placement position 4F at the time of acquiring the X-ray image of the object 2 to be inspected. In this case, the area sensor 4 successively moves to the fifth placement position 4E, the fourth placement position 4D, the seventh placement position 4G, the eighth placement position 4H, and the ninth placement position 4I thereafter. In the embodiment described above, the optical axis of the X-ray generator 3 is parallel to the horizontal direction, but the optical axis of the X-ray generator 3 may be tilted with respect to the horizontal direction. Additionally, in the embodiment described above, the upper and lower direction may be the first direction, and the right and left direction may be the second direction. Furthermore, a direction tilted with respect to the upper and lower direction and the right and left direction may be the first direction.

1. An X-ray inspection apparatus comprising:
an X-ray generator; a two-dimensional X-ray detector that is placed to be opposed to the X-ray generator across an object to be inspected; a rotation mechanism that rotates the X-ray generator and the two-dimensional X-ray detector or rotates the object to be inspected so that, on an outer peripheral side of the object to be inspected, the X-ray generator and the two-dimensional X-ray detector are rotated relatively to the object to be inspected; and a processing module that captures and processes an X-ray image acquired by the two-dimensional X-ray detector, and further comprising:
assuming that a predetermined direction parallel to a detection face of the two-dimensional X-ray detector is a first direction, a direction that is parallel to the detection face and orthogonal to the first direction is a second direction, and a direction of relative rotation of the X-ray generator and the two-dimensional X-ray detector with respect to the object to be inspected is a relative rotation direction, a movement mechanism that translates the two-dimensional X-ray detector or translates the object to be inspected so that the two-dimensional X-ray detector moves at least in the first direction relatively to the object to be inspected; and a control unit to which the X-ray generator, the two-dimensional X-ray detector, the rotation mechanism, and the movement mechanism are connected, wherein,
assuming that a plane including the detection face is a virtual projection plane, and an entire projection image of the object to be inspected projected on the virtual projection plane by X-rays emitted from the X-ray generator is a virtual projection image, the detection face is smaller than the virtual projection image at least in the first direction,
the control unit alternately performs an image acquisition operation of causing the rotation mechanism to rotate the X-ray generator and the two-dimensional X-ray detector by 360° relatively to the object to be inspected and causing the two-dimensional X-ray detector to acquire an X-ray image at every fixed angle, and a movement operation of causing the movement mechanism to relatively move the two-dimensional X-ray detector toward one side of the first direction with respect to the object to be inspected, and causes the two-dimensional X-ray detector to acquire X-ray images of the object to be inspected divided in the first direction at the predetermined position in the second direction, at every fixed angle in the relative rotation direction over 360°, and
the processing module acquires, after capturing a predetermined number of the X-ray images acquired by the two-dimensional X-ray detector, data for creating a CT image including coordinates of the predetermined position in an acquired X-ray image as the captured X-ray image and brightness at the coordinates from the acquired X-ray image, and starts a predetermined arithmetic operation to generate a CT image of the object to be inspected using the data for creating a CT image.

2. The X-ray inspection apparatus according to claim 1, wherein the processing module acquires the data for creating a CT image before capturing all X-ray images required for generating a CT image of the object to be inspected, and starts the arithmetic operation to generate the CT image of the object to be inspected using the data for creating a CT image.

3. The X-ray inspection apparatus according to claim 1, wherein
the detection face is smaller than the virtual projection image in the first direction and the second direction,
assuming that a column of X-ray images is X-ray images of the object to be inspected divided in the first direction at the predetermined position in the second direction, being acquired at every fixed angle in the relative rotation direction over 360°,
when the column of X-ray images is acquired by the two-dimensional X-ray detector, the control unit causes the movement mechanism to move the two-dimensional X-ray detector relatively to the object to be inspected at least in the second direction, alternately performs the image acquisition operation and the movement operation thereafter, and causes the two-dimensional X-ray detector to acquire the next column of X-ray images of the object to be inspected in the second direction.

4. The X-ray inspection apparatus according to claim 2, wherein
the detection face is smaller than the virtual projection image in the first direction and the second direction,
assuming that a column of X-ray images is X-ray images of the object to be inspected divided in the first direction at the predetermined position in the second direction, being acquired at every fixed angle in the relative rotation direction over 360°,
when the column of X-ray images is acquired by the two-dimensional X-ray detector, the control unit causes the movement mechanism to move the two-dimensional X-ray detector relatively to the object to be inspected at least in the second direction, alternately performs the image acquisition operation and the movement operation thereafter, and causes the two-dimensional X-ray detector to acquire the next column of X-ray images of the object to be inspected in the second direction.
